(19) United States
(12) Patent Application Publication
(10) Pub. No.: US 2006/0061786 A1
(43) Pub. Date: Mar. 23, 2006

(54) Apparatus and methods for detecting a color gamut boundary, and for mapping color gamuts using the same

(75) Inventors: Min-ki Cho, Seoul (KR); Heui-keun Choh, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/228,190

(22) Filed: Sep. 19, 2005

(30) Foreign Application Priority Data
Sep. 21, 2004 (KR) 2004-75652

(51) Int. Cl. H04N 1/60

(52) U.S. Cl. 358/1.9

(57) ABSTRACT

An apparatus to detect a color gamut boundary using a spherical coordinate system and an interpolation scheme, and a mapping apparatus and method using the same. The method for detecting a color gamut boundary includes converting color coordinate values of input color samples to spherical coordinate system values (γ, θ, α); performing interpolation by adding at least a color coordinate value by using adjacent color coordinate values when there is one having no color coordinate value of a given number of segments, the spherical coordinate system being uniformly divided into the given number of segments; detecting one having the largest radius r of color coordinate values positioned in the segment for each divided segment; and detecting one closest to a center of each segment of the detected color coordinate values having the largest radius for each segment to detect the color gamut boundary. Thus, it is possible to make an accurate color gamut boundary descriptor.

### CROSS-REFERENCE TO RELATED APPLICATION

This application claims the benefit of Korean Patent Application No. 2004-75652, filed Sep. 21, 2004, in the Korean Intellectual Property Office, the disclosure of which is incorporated herein by reference.

### BACKGROUND OF THE INVENTION

1. Field of the Invention

The present invention relates generally to color gamut boundary detection and mapping. More specifically, embodiments of the present invention relate to apparatus and methods for detecting a color gamut boundary by using both a spherical coordinate system and an interpolation scheme, and apparatus and methods for mapping color gamuts using the detected color gamut boundary.

2. Description of the Related Art

Generally, color input and output devices that reproduce colors, such as monitors, scanners, cameras and printers, use different color spaces or color models according to their fields of use. For example, for a color image, a printer uses a cyan-magenta-yellow (CMY) color space, a color cathode ray tube (CRT) monitor or a computer graphics device uses a red-green-blue (RGB) color space, and devices handling color, chroma and lightness use a hue-saturation-lightness (HSI) color space. A CIE color space is often used to define so-called device-independent colors that can be accurately reproduced by any device. Representative examples include CIE-XYZ, CIE-Lab and CIE-Luv color spaces.

There may be a difference, in a range of colors that can be represented, namely, a color gamut as well as the color space, between the color input and output devices. When observed using different input and output devices, the same image may be viewed differently due to the difference in the color gamut. Accordingly, if there is a difference in the color gamut between an input color signal and a device reproducing the input color signal, there is a need for color gamut mapping in which the input color signal is properly converted so that the color gamuts match each other, thus improving color reproduction.

FIG. 1 is a schematic representation of a typical color gamut mapping operation. S1 and S2 indicate a color gamut of a source device and a color gamut of a target device, respectively. X1 and X2 indicate an original image from the source device and an image after mapping, respectively.

Referring to FIG. 1, color gamut boundary descriptors (GBD) of given source and target devices are first made. In FIG. 1 the color gamut of the source device is wider than that of the target device. Upon color gamut mapping using the color gamut boundary descriptor, an original image from the source device is mapped into the color gamut of the target device. That is, upon color gamut mapping, the X1 image of the source device outside the color gamut of the target device is mapped into the X2 image on the color gamut boundary of the target device. Mapping the original image of the source device outside the target device into the color gamut of the target device makes it possible for the target device to reproduce colors.

Generally, mapping the color gamut between different color input and output devices is performed using lightness and chroma, leaving hue unchanged, after a color space of an input color signal is converted. Specifically, the input color signal is converted from a device-dependent color space (DDCS) such as RGB or cyan-magenta-yellow-black (CMYK) to a device-independent color space (DICS) such as CIE-XYZ or CIE-Lab, and in turn the device independent color space is converted to a luminosity-chroma-hue (LCH) coordinate system representing hue, lightness and chroma, and thereafter color gamut mapping for lightness (L) and chroma (C) is made on a plane where the color is uniform, namely, on an LC plane. The color gamut of the device having the device independent color space or LCH may perform the color gamut mapping.

FIGS. 2A and 2B are schematic representations of a conventional method for detecting a color gamut boundary. FIG. 2A illustrates a method for detecting a color gamut boundary by using an interpolation scheme, and FIG. 2B illustrates a method for detecting a color gamut boundary using a spherical coordinate system. X3 is an interpolated color coordinate value, and X4 to X6 are color coordinate values used to interpolate X3.

Referring to FIG. 2A, in the method for detecting a color gamut boundary by using the interpolation scheme, a color coordinate system in a CIE-Lab coordinate system is uniformly divided in an arbitrary manner. A color gamut boundary descriptor is made using Lab values of a certain number of color samples at divided points and color coordinate values created by the interpolation scheme when there are no Lab values at the divided point. In FIG. 2A, the X3 value positioned at the divided point is a color coordinate value created by the interpolation scheme using the X4, X5 and X6 values positioned around the divided point.

However, in the case of detecting the color gamut boundary by using the interpolation scheme, a detection error of the color gamut boundary may occur due to an interpolation scheme error. The color gamut boundary descriptor, which is made by uniformly dividing the CIE-Lab color coordinate system, may not describe specific pure colors, such as red (R), green (G), blue (B), cyan (C), magenta (M), and yellow (Y).

The method for detecting a color gamut boundary by using the spherical coordinate system as shown in FIG. 2B is described in an article entitled ‘Color Imaging Vision and Technology’ by Jan. Morovic, pp 255 to 259. In the method for detecting the color gamut boundary by using the spherical coordinate system, CIE-Lab values of a certain number of measured color samples are first converted to spherical coordinate system values by a spectrophotometer. The spherical coordinate system values are uniformly divided and then a color coordinate value having the largest radius is stored in each divided region. One having the largest radius of the converted spherical coordinate system values is a value corresponding to the boundary of the color gamut. Accordingly, the color gamut boundary can be detected by detecting data having the largest radius in each divided region.

However, the method for detecting the color gamut boundary using the spherical coordinate system may fail to store data due to non-existence of the data in some divided regions. The data storage fails when a certain number of measured color samples have insufficient color, namely, no data, or a color that cannot be reproduced by the target device. The data for the region where there is no data may be calculated by using data in the ambient regions and the interpolation scheme. However, it is difficult to calculate data for successive regions where there is no data.

### SUMMARY OF THE INVENTION

Accordingly, an aspect of the present invention an apparatus to detect a color gamut boundary capable of accurately detecting the color gamut boundary and mapping color gamuts, by detecting a color gamut boundary using a spherical coordinate system and an interpolation scheme and mapping color gamuts using the detected color gamut boundary, a mapping apparatus using the same, and a method therefor.

The above aspect of the present invention is substantially realized by providing an apparatus to detect color gamut boundary, including a color coordinate converting unit to convert color coordinate values of input color samples to spherical coordinate system values (γ, θ, α), an interpolating unit to add one color coordinate value by using adjacent color coordinate values when there is one having no color coordinate value of a given number of segments, the spherical coordinate system being uniformly divided into the given number of segments, a determining unit to detect one having the largest radius r of color coordinate values positioned in the segment for each divided segment, and a color gamut detecting unit to detect one closest to a center of each segment of the detected color coordinate values having the largest radius for each segment to detect the color gamut boundary.

The apparatus may include a storage unit that stores the color coordinate values for the respective divided segments and stores the color coordinate values having the largest radius detected by the determining unit.

The color gamut detecting unit may include a calculating unit to calculate a point of central θ for each of the segments of a plane having a specific angle α and select one having the smallest error of color coordinate values at the left and right of a point of central α and θ as specific angles for each segment, and an intersection detecting unit to detect an intersection between the selected color coordinate value and the plane having the specific angle.

In accordance with another embodiment of the present invention, there is provided an apparatus for mapping a color gamut of a source device into a color gamut of a target device by using the color gamut boundary detected by the apparatus for detecting a color gamut boundary.

In accordance with another aspect of the present invention, there is provided a method for detecting a color gamut boundary, including: converting color coordinate values of input color samples to spherical coordinate system values (γ, θ, α), performing interpolation by adding at least a color coordinate value by using adjacent color coordinate values when there is one having no color coordinate value of a given number of segments, the spherical coordinate system being uniformly divided into the given number of segments, detecting one having the largest radius r of color coordinate values positioned in the segment for each divided segment, and detecting one closest to a center of each segment of the detected color coordinate values having the largest radius for each segment to detect the color gamut boundary.

When the color coordinate values of the input color samples are Lab color coordinate values, converting the color coordinate values may be performed by the following equation:

$$γ = {[ {( L - {L}_{E} )}^{2} + {( a - {a}_{E} )}^{2} + {( b - {b}_{E} )}^{2} ]}^{1 / 2} , \\ θ = {tan}^{- 1} [ \frac{L - {L}_{E}}{{( {( a - {a}_{E} )}^{2} + {( b - {b}_{E} )}^{2} )}^{1 / 2}} ] , \\ α = {tan}^{- 1} ( \frac{b - {b}_{E}}{a - {a}_{E}} ) ,$$

where (γ, θ, α) is the spherical coordinate system value, (L, a, b) is the Lab coordinate system value, and L_{E}, a_{E} and b_{E} are any reference values in the Lab coordinate system.

The method may further include storing the color coordinate values of the divided segments and storing the detected color coordinate values having the largest radius.

The operation of detecting a color coordinate value closest to a center of each segment may include calculating a central θ value for each of the segments of a plane having a specific angle α and selecting one having the smallest error of color coordinate values at the left and right of a point of central α and θ as specific angles for each segment, and detecting an intersection between the selected color coordinate value and the plane having the specific angle.

In accordance with yet another aspect of the present invention, there is provided a method for mapping a color gamut of a source device into a color gamut of a target device by using the color gamut boundary detected by the method for detecting a color gamut boundary.

An original image of the source device may be mapped into an intersection between a straight line and the detected color gamut boundary, the straight line linking a center of a plane having a specific angle α to the original image of the source device.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic representation of a typical color gamut mapping operation;

FIGS. 2A and 2B are schematic representations of a conventional method for detecting a color gamut boundary;

FIG. 3 is a block diagram of an apparatus to detect a color gamut boundary and map color gamuts, according to an embodiment of the present invention;

FIG. 4 is a schematic representation of a color gamut detected by an apparatus to detect a color gamut boundary and map color gamuts, according to an embodiment of the present invention;

FIGS. 5A and 5B are schematic representations of respective operations of a color gamut detecting unit and a mapping unit in the apparatus to detect a color gamut boundary and map color gamuts, according to an embodiment of the present invention;

FIG. 6 is a flowchart of a method for detecting a color gamut boundary, according to an embodiment of the present invention;

FIG. 7 is a flowchart of a method for mapping color gamuts, according to an embodiment of the present invention; and

FIG. 8 is a schematic representation of a result obtained by applying a method for detecting a color gamut boundary, according to an embodiment of the present invention.

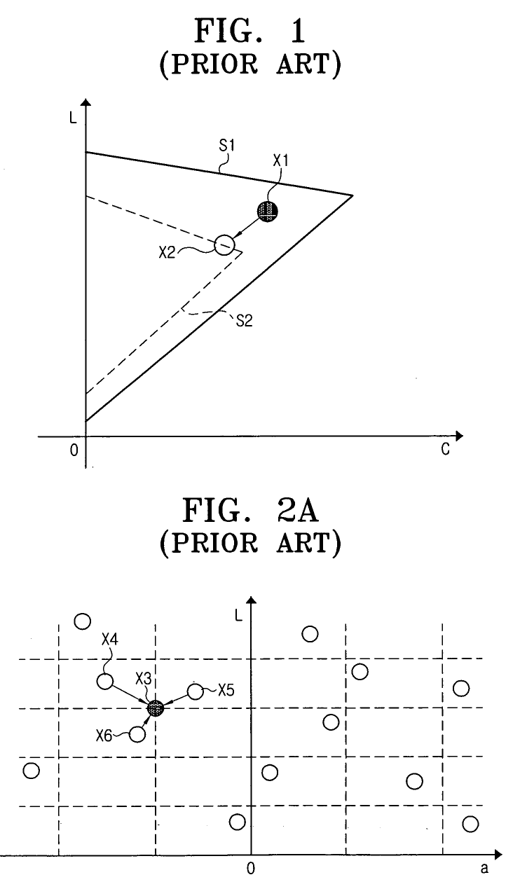

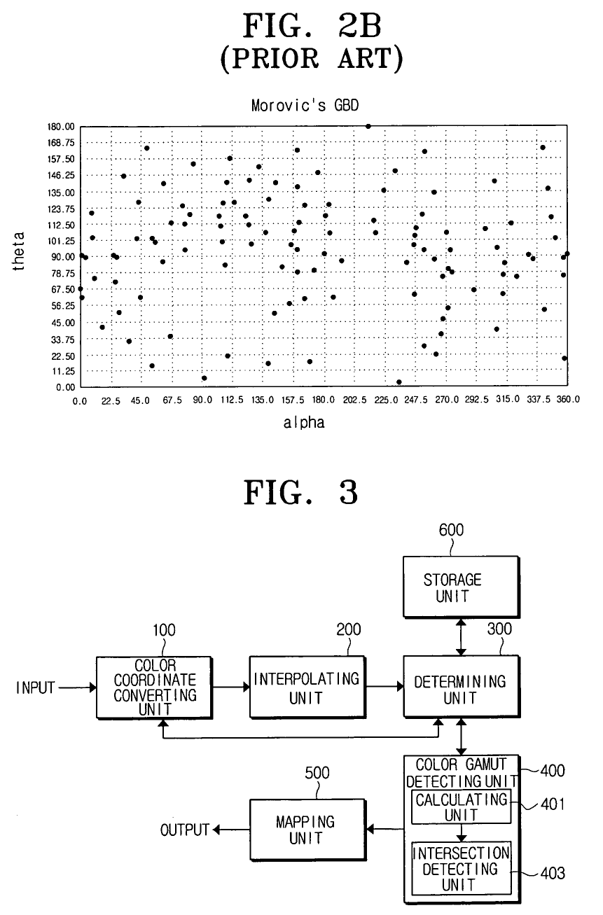

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

An exemplary embodiment is discussed wherein a color reproducing target device is embodied as a printer. However, it should be apparent to one of ordinary skill in the art that the present invention is not limited to such a configuration. Accordingly, the color reproducing target device may alternatively be embodied in many forms, including not by way of limitation, a monitor or a device display.

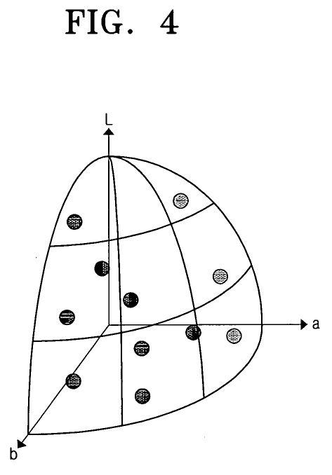

FIG. 3 is a block diagram of an apparatus to detect a color gamut boundary and map color gamuts, according to an embodiment of the present invention. Referring to FIG. 3, an apparatus to detect a color gamut boundary and map color gamuts according to an embodiment of the present invention may include a color coordinate converting unit 100, an interpolating unit 200, a determining unit 300, a color gamut detecting unit 400, a mapping unit 500, and a storage unit 600. The color gamut detecting unit 400 may include a calculating unit 401 and an intersection detecting unit 403.

The color coordinate converting unit 100 may convert color coordinate system values of input color samples measured by a spectrophotometer to spherical coordinate system values, divide the spherical coordinate system into a predetermined number of segments, and initialize the segments. That is, N×N×N input color samples may be prepared, output from the printer, and measured by the spectrophotometer. Specifically, the color coordinate converting unit 100 may convert CIE-Lab coordinate system values of the measured color samples to the spherical coordinate system values by using a spherical coordinate system conversion equation. The color coordinate converting unit 100 may divide the converted color coordinate values in the spherical coordinate system format (γ, θ, α) into a predetermined number of segments and initialize the segments, with the radius (r) of spherical coordinate system values in the divided segments being zero. The division of the segments may be made based on the θ and α values.

The interpolating unit 200 may expand the input color samples by using the interpolation scheme. That is, when there is no color coordinate value in the divided segment, the interpolating unit 200 may perform interpolation to add the color coordinate value to the segment. In order to detect the color gamut boundary, the color gamut boundary samples may be detected from the input color samples. In an area for which color gamut boundary samples are not detected from the input color samples, the interpolating unit 200 may perform interpolation to the color gamut boundary samples by using ambient color coordinate system values.

The determining unit 300 may compare a stored γ value for each segment to the γ′ value calculated by the spherical coordinate system conversion equation. When the γ′ value is greater than the r value, the determining unit 300 may store the γ′ in the storage unit 600. An initial γ value stored for each segment may become zero due to the initialization of the segments in the color coordinate converting unit 100. Specifically, the determining unit 300 may compare a radius (stored in the storage unit 600) of the data present for each segment to a radius of the converted values in the spherical coordinate system format. In other words, the determining unit 300 may select a specific one of the respective segments, which may be divided based on the θ and α values of the spherical coordinate system values of the color coordinate converting unit 100, compare the stored γ of the selected segment to the calculated γ′, and store the greater value. Thus, the determining unit 300 may store the spherical coordinate system value having the largest radius in each segment.

The color gamut detecting unit 400 may include a calculating unit 401 and an intersection detecting unit 403. The color gamut detecting unit 400 may convert the color gamut of the target device into the LCH color coordinate by using the color coordinate values at the color gamut boundary detected by the interpolating unit 200.

The calculating unit 401 may calculate a α value based on the detected color gamut boundary color coordinate value, and may calculate θ_{c} as a central θ for each segment in the segments containing the α. Furthermore, the calculating unit 401 may detect data having a minimum error from data at the left and right of the α and θ_{c} for each segment.

The intersection detecting unit 403 may detect intersections between the data having the minimum error calculated by the calculating unit 401 and the calculated a plane. The intersections detected by the intersection detecting unit 403 may correspond color gamut boundary values at which colors are uniform in the LCH color space. That is, the detected intersections correspond to the color gamut boundary values on the LC plane.

The mapping unit 500 may perform mapping of the original images from the source device using a plane linking the intersections in the LCH color space detected by the intersection detecting unit 403, namely, using the α plane. If the original image of the source device is present outside the color gamut boundary of the target device, the mapping unit 500 may map the original image of the source device into an intersection between a straight line linking the center of the α plane to the original image of the source device and the color gamut boundary of the target device.

The storage unit 600 may store the spherical coordinate system value having the largest radius detected for each segment by the determining unit 300. Specifically, the storage unit 600 may store the initialized values of the segments divided by the color coordinate converting unit 100. The determining unit 300 may compare the radius value stored in the storage unit 600 to the radius value calculated using the spherical coordinate system conversion equation and store a greater value in the storage unit 600.

FIG. 4 is a schematic representation of a color gamut detected by an apparatus to detect a color gamut boundary and map color gamuts, according to an embodiment of the present invention. Referring to FIG. 4, a color coordinate value of the input color sample may be converted into the spherical coordinate system value and in turn, the spherical coordinate system may be divided into a predetermined number of segments. Data may be added to a segment having no data by means of interpolation to represent the detected color gamut boundary.

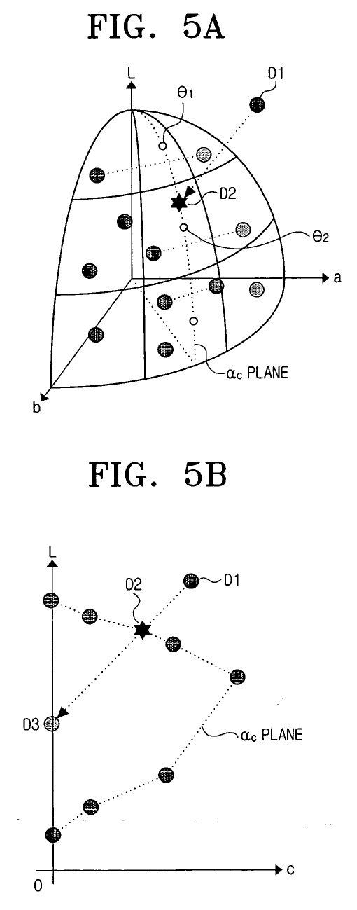

FIGS. 5A and 5B are schematic representations of respective operations of the color gamut detecting unit 400 and the mapping unit 500 of the apparatus to detect a color gamut boundary and map color gamuts, according to an embodiment of the present invention. FIG. 5A illustrates an operation of the color gamut detecting unit 400 according to an embodiment of the present invention, and FIG. 5B illustrates an operation of the mapping unit 500 according to an embodiment of the present invention. D1 indicates the original image of the source device positioned outside the color gamut of the target device, and D2 indicates mapping D1 into the color gamut boundary of the target device. D3 indicates a center of the α_{c} plane on the LC plane.

Referring to FIG. 5A, the color gamut detecting unit 400 represents the color gamut boundary of the target device, which may be detected by the color coordinate converting unit 100, the interpolating unit 200 and the determining unit 300, on the LC plane in the LCH color space.

The calculating unit 401 of the color gamut detecting unit 400 may calculate α values on the detected color gamut boundary of the target device. The calculated α values may be referred to as α_{c}. The calculating unit 401 may detect a point of a central θ in each segment including the α_{c}. The point of the central θ may be referred to as θ_{c}. The calculating unit 401 may detect data having the smallest error with α_{c} and θ_{c} of data at the left and right of the α_{c} and θ_{c} for each segment. This is intended to accurately describe the color gamut boundary by detecting the data having the smallest error with the center of the segment upon describing the color gamut boundary of the target device on the LC plane.

The intersection detecting unit 403 may detect an intersection between the data having the smallest error detected by the calculating unit 401 and the α_{c} plane to describe the α_{c} plane on the LC plane in the LCH color space.

Thus, the color gamut detecting unit 400 may use the color coordinate values of the color gamut boundary detected by the color coordinate converting unit 100, the determining unit 200, and the interpolating unit 300 to accurately describe the color gamut boundary of the target device on the LC plane.

Referring to FIG. 5B, the mapping unit 500 may calculate a linear equation linking the original image of the source device and the center of the α_{c} plane on the color gamut boundary described in the LCH color space. The mapping unit 500 may use the calculated linear equation to perform mapping of the original image of the source device into the boundary value of the α_{c} plane present on the straight line. That is, D1 that is the original image of the source device may be mapped into D2 that is an intersection between the straight line linking D1 to D3 as the center of the α_{c} plane and the boundary of the α_{c} plane.

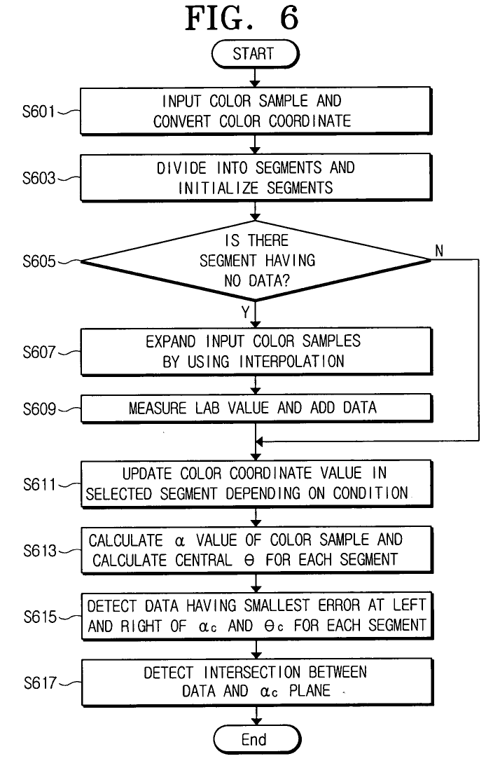

FIG. 6 is a flowchart of a method for detecting a color gamut boundary, according to an embodiment of the present invention. Referring to FIG. 6, an arbitrary color sample as prepared is converted from a Lab value to a spherical coordinate system value (S601). Specifically, the arbitrary color sample as prepared may be output to the printer being the target device, the Lab value of the output color sample may be measured by the spectrophotometer. The measured Lab value may be converted into the spherical coordinate system format (γ, θ, α). The Lab value of the input color sample may be converted to the spherical coordinate system value by the following Equation 1:

$$γ = {[ {( L - {L}_{E} )}^{2} + {( a - {a}_{E} )}^{2} + {( b - {b}_{E} )}^{2} ]}^{1 / 2} , \\ θ = {tan}^{- 1} [ \frac{L - {L}_{E}}{{( {( a - {a}_{E} )}^{2} + {( b - {b}_{E} )}^{2} )}^{1 / 2}} ] , \\ α = {tan}^{- 1} ( \frac{b - {b}_{E}}{a - {a}_{E}} ) , \qquad [ Equation 1 ]$$

where (γ, θ, α) is the spherical coordinate system value, and (L, a, b) is the Lab coordinate system value. L_{E}, a_{E} and b_{E} are any reference values in the Lab coordinate system. It is assumed that (L_{E}, a_{E}, b_{E}) is (50, 0, 0).

Subsequently, the changed spherical coordinate system may be divided into a predetermined number of segments, and the divided segments may be initialized (S603). The segments may be initialized, with a radius being zero wherein the radius is a γ value of each of the given number of divided segments of the color samples. The spherical coordinate system values of the thus initialized segments may be stored in the storage unit 600. The conversion of the color sample to the spherical coordinate system format, the division into the segments, and the initialization of the segments may be performed by the color coordinate converting unit 100.

It may be determined whether there are any segments having no data (S605). If there is a segment having no data on the color coordinate value, data may be created for the segment by using various interpolation schemes (S607). That is, if there is no data in the segment, data may be created by the various interpolation schemes using ambient data. The created data may be the Lab color coordinate value.

The color sample containing the segment having the data created by the interpolation scheme may be output back by a printer as the target device, and the Lab value thereof may be measured by the spectrophotometer. The measured Lab value may be used as additional data for the input color sample depending on the measurement result (S609).

One of the specific respective divided segments may be selected based on the θ and α values of the converted color sample in the spherical coordinate system format. The color coordinate value of the segment stored in the storage unit 600 may be updated with that of the selected segment depending on a certain condition (S611). When the color coordinate values present in the selected specific segment is converted into the spherical coordinate system format, the r value of the specific segment stored in the storage unit 600 and the γ′ value converted using Equation 1 of the color coordinate values present in the specific segment may be compared to each other. If it is determined that the γ′ value is greater than the γ value, the greater γ′ value may be stored in the storage unit 600. If there is another color coordinate value in the specific segment, the r″ value of the color coordinate value converted using Equation 1 may be compared to the r′ value pre-stored in the storage unit 600. If the γ″ value is greater than the γ′ value, the radius of the specific segment may be updated with the γ″ value and the updated the radius may be stored in the storage unit 600. That is, a color coordinate value having the largest radius value of the color coordinate values present in the specific segment may be stored in the storage unit 600. This is intended to detect the color gamut boundary by storing the largest radius in each segment and detecting color coordinate values close to the color gamut boundary.

If it is determined that there is no segment having no data about the color coordinate value (S605), a color coordinate value having the largest radius value of the color coordinate values present in the specific segment may be stored in the storage unit 600 through the interpolation without needing to add the data.

Next, an α value of the color sample may be calculated, and a point of central θ for each segment containing the calculated α value may be selected (S613). At this time, it is assumed that the calculated α is α_{c} and the point of central θ for each segment is θ_{c}.

Data having the smallest error of data at the left and right of the α_{c} and θ_{c} may be detected for each segment including the segment containing the α value (S615). This is intended to describe the color gamut boundary of the target device in the LCH color space by using data having the smallest error.

An intersection between the detected data having the smallest error and the α_{c} plane may then be detected (S617). The detection of the intersection between the detected data having the smallest error and the α_{c} plane allows the α_{c} plane to be described on the LC plane in the LCH color space.

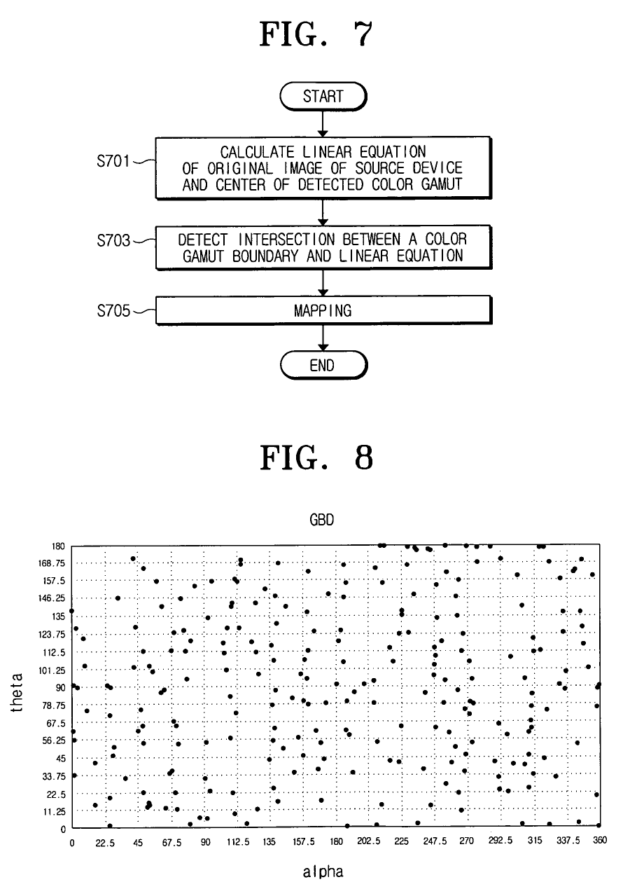

FIG. 7 is a flowchart of a method for mapping color gamuts, according to an embodiment of the present invention. Referring to FIG. 7, the color gamut of the source device can be mapped into the color gamut of the target device by using the detected color gamut boundary of the target device, as described in FIG. 6. A linear equation may first be calculated which may link a center of the detected color gamut, namely, a center of the α_{c} plane to an original image of the source device positioned outside the α_{c} plane (S701).

An intersection between the boundary of the α_{c} plane and the calculated linear equation may be detected (S703). The original image of the source device present outside the α_{c} plane may be mapped into the detected intersection (S705). If the original image of the source device is present outside the α_{c} plane, the original image of the source device may be mapped into the color gamut of the target device so that the original image is reproduced by the target device. The original image of the source device present outside the α_{c} plane may be mapped into the color gamut boundary of the target device toward a center of the α_{c} plane.

FIG. 8 is a schematic representation of a result obtained by applying a method for detecting a color gamut boundary, according to an embodiment of the present invention. Referring to FIG. 8, when the converted color samples of the spherical coordinate system values are divided into 16×16 segments, the color samples present in the segments may be as shown in FIG. 8. In this case, the value of an input color sample may be converted into the spherical coordinate system value, and data may be added to a segment corresponding to color gamut boundary having no color sample by using the interpolation scheme, thus expanding the input color sample. Accordingly, the segment corresponding to the color gamut boundary may include a number of data, thus accurately detecting the color gamut boundary.

As described above, according to embodiments of the present invention, there is no segment having no data, unlike the method with the spherical coordinate system. It is possible to make an accurate color gamut boundary descriptor (GBD) by using an actual color gamut boundary sample rather than a virtual sample calculated by the interpolation scheme, unlike the method with an interpolation scheme.

Furthermore, it is possible to accurately detect a color gamut boundary by using data having the smallest color gamut boundary descriptor error upon making the a plane for the color sample. The accurate detection of the color gamut boundary allows accurate color gamut mapping.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to detect a color gamut boundary, comprising:
a color coordinate converting unit to convert color coordinate values of input color samples to spherical coordinate system values (γ, θ, α);
an interpolating unit to add a color coordinate value by using adjacent color coordinate values when there is a segment having no color coordinate value among a given number of segments uniformly divided from the spherical coordinate system;
a determining unit to detect a color coordinate value having a largest radius r among color coordinate values positioned in the segment for each divided segment; and
a color gamut detecting unit to detect a color gamut boundary by detecting a color coordinate value having a largest radius and closest to a center of each segment of the detected color coordinate values having the largest radius for each segment.

2. The apparatus according to claim 1, further comprising a storage unit that stores the color coordinate values for the respective divided segments and stores the color coordinate values having the largest radius detected by the determining unit.

3. The apparatus according to claim 1, wherein the color gamut detecting unit comprises:
a calculating unit to calculate a point of central θ for each of the segments of a plane having a specific angle α, and select a color coordinate value having a smallest error of color coordinate values at the left and right of a point of central α and θ as specific angles for each segment; and
an intersection detecting unit to detect an intersection between the selected color coordinate value and the plane having the specific angle.

4. An apparatus, comprising:
a color coordinate converting unit to convert color coordinate values of input color samples to spherical coordinate system values (γ, θ, α);
an interpolating unit to add a color coordinate value by using adjacent color coordinate values when there is a segment having no color coordinate value among a given number of segments uniformly divided from the spherical coordinate system;
a determining unit to detect a color coordinate value having a largest radius r among color coordinate values positioned in the segment for each divided segment;
a color gamut detecting unit to detect a color gamut boundary by detecting a color coordinate value having a largest radius and closest to a center of each segment of the detected color coordinate values having the largest radius for each segment; and
a mapping unit to map a color gamut of a source device into a color gamut of a target device by using the color gamut boundary detected by the color gamut detecting unit.

5. A method for detecting a color gamut boundary, comprising:
converting color coordinate values of input color samples to spherical coordinate system values (γ, θ, α);
interpolating by adding at least a color coordinate value by using adjacent color coordinate values when there is any segment having no color coordinate value among a given number of segments, the spherical coordinate system being uniformly divided into the given number of segments;
detecting a color coordinate value having the largest radius r of color coordinate values positioned in the segment for each divided segment; and
detecting a color coordinate value closest to a center of each segment of the detected color coordinate values having the largest radius for each segment to detect the color gamut boundary.

6. The method according to claim 5, wherein when the color coordinate values of the input color samples are Lab color coordinate values, converting the color coordinate values is performed by the following equation:
$$γ = {[ {( L - {L}_{E} )}^{2} + {( a - {a}_{E} )}^{2} + {( b - {b}_{E} )}^{2} ]}^{1 / 2} , \\ θ = {tan}^{- 1} [ \frac{L - {L}_{E}}{{( {( a - {a}_{E} )}^{2} + {( b - {b}_{E} )}^{2} )}^{1 / 2}} ] , \\ α = {tan}^{- 1} ( \frac{b - {b}_{E}}{a - {a}_{E}} ) ,$$
where (γ, θ, α) is the spherical coordinate system value, (L, a, b) is the Lab coordinate system value, and L_{E}, a_{E} and b_{E} are any reference values in the Lab coordinate system.

7. The method according to claim 5, further comprising storing the color coordinate values of the divided segments and storing the detected color coordinate values having the largest radius.

8. The method according to claim 5, wherein the operation of detecting a color coordinate value closest to a center of each segment comprises:
calculating a central θ value for each of the segments of a plane having a specific angle α and selecting a color coordinate value having the smallest error of color coordinate values at the left and right of a point of central α and θ as specific angles for each segment; and
detecting an intersection between the selected color coordinate value and the plane having the specific angle.

9. A method, comprising:
converting color coordinate values of input color samples to spherical coordinate system values (γ, θ, α);
interpolating by adding at least a color coordinate value by using adjacent color coordinate values when there is any segment having no color coordinate value among a given number of segments, the spherical coordinate system being uniformly divided into the given number of segments;
detecting a color coordinate value having the largest radius r of color coordinate values positioned in the segment for each divided segment;
detecting a color coordinate value closest to a center of each segment of the detected color coordinate values having the largest radius for each segment to detect a color gamut boundary; and
mapping a color gamut of a source device into a color gamut of a target device by using the color gamut boundary.

10. The method according to claim 9, comprising mapping an original image of the source device into an intersection between a straight line and the detected color gamut boundary, the straight line linking a center of a plane having a specific angle α to the original image of the source device.

11. A method, comprising:
receiving data representing a color gamut; and
detecting a boundary of the color gamut using at least a spherical coordinate system and a interpolation scheme.

12. The method according to claim 11, wherein the detecting of the boundary of the color gamut using at least a spherical coordinate system and a interpolation scheme comprises:
interpolating color data for a segment containing no color data; and
detecting the boundary of the color gamut using the color data.

13. The method according to claim 11, wherein the data representing the color gamut comprises:
color coordinate values.

14. The method according to claim 11, further comprising:
mapping a color gamut of a source device into a color gamut of a target device by using the boundary of the color gamut.
